(19) United States
(12) Patent Application Publication
(10) Pub. No.: US 2026/0046100 A1
(43) Pub. Date: Feb. 12, 2026

(54) SHARED RADIO UNIT ARCHITECTURES SUPPORTING NON-STATIC TIME DIVISION DUPLEXING

(71) Applicant: DISH Wireless L.L.C., Englewood, CO (US)

(72) Inventors: Mehdi Alasti, Arlington, VA (US); Dilip Tandekar, Herndon, VA (US); Sourabh Gupta, Ashburn, VA (US)

(21) Appl. No.: 18/795,792

(22) Filed: Aug. 6, 2024

(51) Int. Cl. H04L 5/00; H04L 5/14; H04W 72/0446

(52) U.S. Cl. CPC H04L 5/0096; H04L 5/14; H04W 72/0446

(57) ABSTRACT

Technologies for shared radio unit (RU) architectures supporting non-static time division duplexing (TDD) are described. One method includes receiving, from a guest operator assigned to a sub-band of a frequency band of a telecommunications network implementing a shared radio unit architecture, a request to modify a downlink to uplink ratio associated with the sub-band to implement time division duplexing, and modifying the downlink to uplink ratio.

### BACKGROUND

A telecommunication network, such as a cellular network, can include a radio access network (RAN) that can enable communication with user equipment (UE). In particular, UE can communicate with a base station of the RAN. In a fifth generation (5G) wireless network (referred to as a “5G network”), the base station is referred to a Next Generation Node B, a “gNodeB,” or a “gNB.”

A radio unit (RU) is a component of a telecommunication network (e.g., of the RAN) that can transmit and receive radio signals to facilitate communication between the RAN and the UE. For example, an RU can convert digital baseband signals into radio frequency (RF) signals, and transmit the RF signals to UE. As another example, an RU can receive RF signals to UE, and convert the RF signals into digital baseband signals. Examples of RUs include multiple-input multiple-output (MIMO) RUs, small cell RUs, integrated RUs, etc.

### BRIEF DESCRIPTION OF THE SEVERAL VIEWS OF THE DRAWINGS

The present disclosure is illustrated by way of example, and not by way of limitation, in the figures of the accompanying drawings.

FIGS. 1A-1B are block diagrams of example telecommunications networks implementing shared radio unit (RU) architectures, according to some embodiments.

FIGS. 2A-3 are diagrams illustrating example implementations of shared radio unit (RU) architectures supporting non-static time division duplexing (TDD), according to some embodiments.

FIGS. 4-5 are flow diagrams of example methods for implementing shared radio unit (RU) architectures supporting non-static time division duplexing (TDD), according to some embodiments.

FIG. 6 depicts a 5G network including a radio access network (RAN) and a core network, according to some embodiments.

FIG. 7 depicts a radio access network and a core network for providing a communications channel (or channel) between user equipment and data network, according to some embodiments.

FIGS. 8A-8B depict a radio access network, according to some embodiments.

### DETAILED DESCRIPTION

Technologies for implementing shared radio unit (RU) architectures supporting non-static time division duplexing (TDD) are described. The following description sets forth numerous specific details, such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or presented in simple block diagram format to avoid obscuring the present disclosure unnecessarily. Thus, the specific details set forth are merely exemplary. Particular embodiments may vary from these exemplary details and still be contemplated to be within the scope of the present disclosure.

In shared RU architectures, a “host” operator can furnish shared RU, spectrum, power amplifiers, filters, antennas, wiring and associated hardware, whereas several “guest” operators lease resources, such as bandwidth, from the “host” operator, facilitated through contractual agreements. Each “guest” operator maintains ownership of its (virtualized) distribution units (DUs), centralized units (CUs), network cores (e.g., 5G core), IP Multimedia Subsystem (IMS), etc., hosted in the cloud environment of their chosen cloud provider. Each “guest” operator establishes connections between its DUs and the shared RU via an open front-haul interface. Resources leased by each “guest” operator may vary depending on factors such as the time of day, day of the week, geographical location, etc., as outlined in the contractual agreement between the “host” operator and the “guest” operators. However, some resources allocated to the “guest” operators are static or otherwise fixed according to the lease agreements.

Examples of techniques that can be used to transmit and receive data within in a telecommunications network (e.g., 5G network) include frequency division duplexing (FDD) and time division duplexing (TDD).

FDD is a technique that uses separate frequency bands for uplink (UL) transmissions of signals sent from a UE to the RAN (e.g., uploading data) and downlink (DL) transmissions of signals sent from the RAN to the UE (e.g., downloading data). FDD is a type of full-duplex communication, which means that one device can transmit and receive data. FDD can allow for simultaneous transmission and reception of data, which can result in faster speeds and lower latency.

In contrast to FDD, TDD allows UL and DL transmissions to be made over the same frequency band by dividing the time domain into time slots, where each time slot is dedicated to either UL transmission or DL transmissions. For example, the UE and the RAN can communicate on a single channel or frequency with different time slots for both UL and DL transmissions. Since the division of the time domain into time slots can utilize precise timing and synchronization methods, TDD can be more complex to implement than FDD.

TDD can be more complex to implement than FDD as it utilizes precise timing and synchronization in the division of the time domain into time slots. In TDD, a downlink-to-uplink (DL:UL) ratio refers to a ratio of a number of time slots allocated to DL transmissions and a number of time slots allocated to UL transmissions. Some typical DL:UL ratios include, 3:1 and 2:1. For example, a DL:UL ratio of 4:1 means that 4:1 for every 4 time slots used for DL transmissions, 1 time slot is used for UL transmission. Adjusting the DL:UL ratio can optimize network performance based on traffic patterns and user needs. For example, a higher DL:UL ratio can favor DL-heavy applications such as video streaming, while a lower DL:UL ratio can favor UL-heavy applications such as online gaming or voice calls. Therefore, TDD may be preferable to use for applications that have asymmetric traffic patterns, in which the amount of UL traffic is different from the amount of DL traffic. Additionally, TDD can be more spectrum efficient and less costly to implement than FDD, as it does not require separate frequency bands for uplink and downlink signals.

Currently, DL:UL ratios are static for all operators on the same frequency band to reduce or prevent cross-link interference (CLI) between DL and UL transmissions of neighboring operators. Generally, CLI occurs when multiple devices are transmitting on the same frequency channel, causing signal interference. CLI can lead to signal degradation, reduced data rates, increased transmission errors, and decreased network capacity.

In a shared RU architecture implementing TDD, CLI can occur when one guest operator is sending UL traffic to the shared RU and a neighboring guest operator is receiving DL traffic from the shared RU in the same time slot. Therefore, non-static TDD (e.g., dynamic or semi-static) may not be practical to implement in a typical shared RU architecture, as it could result in CLI between neighboring guest operators within the shared RU architecture.

Aspects and embodiments of the present disclosure address these challenges by enabling shared RU architectures that support non-static TDD. More specifically, a shared RU architecture described herein can support non-static (e.g., dynamic or semi-static) DL:UL ratios for one or more guest operators of the shared RU architecture. A semi-static DL:UL ratio is a DL:UL ratio that is static for some period of time, but is adjusted occasionally based on network conditions and/or traffic patterns. To do so, a host operator of the shared RU architecture can divide a frequency band into multiple frequency sub-bands (“sub-bands”). The host operator can then assign, to each sub-band, a respective guest operator of the shared RU architecture. At least one sub-band can have a flexible number of DL slots and UL slots across multiple time slots of the time domain. The host operator can manage CLI with respect to the guest operators using one or more CLI management techniques (e.g., between neighboring guest operators). Examples of CLI management techniques include interference cancellation (e.g., using signal processing techniques to cancel out known or predicted interference), power control (e.g., adjusting transmission power to minimize interference while maintaining acceptable signal quality), beamforming (e.g., directing transmissions away from interfering receivers), sub-band muting (e.g., temporarily disabling transmission and/or reception for one or more sub-bands to reduce interference), etc.

It may be the case that at least one guest operator of the shared RU architecture is adjacent to a neighboring operator that is not included in the shared RU architecture. For example, the at least one guest operator can be at least one boundary or edge guest operator of the shared RU architecture. In some embodiments, the host operator does not receive transmission data from the neighboring operator that can be used to implement CLI management. In these embodiments, to prevent CLI between the at least one guest operator and the neighboring operator, the DL:UL ratio of the at least one guest operator is static. In alternative embodiments, the host operator can receive transmission data from the neighboring operator that can be used to implement CLI management. In these embodiments, the DL:UL ratio of the at least one guest operator can be non-static (e.g., semi-static or dynamic). Further details regarding shared RU architectures supporting non-static TDD as will now be described in more detail below.

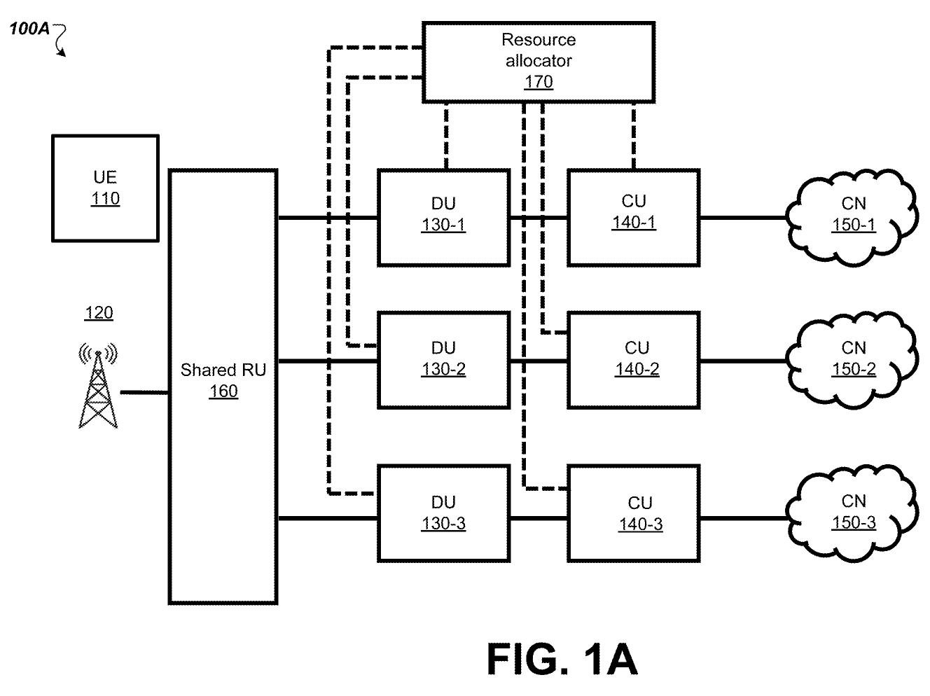

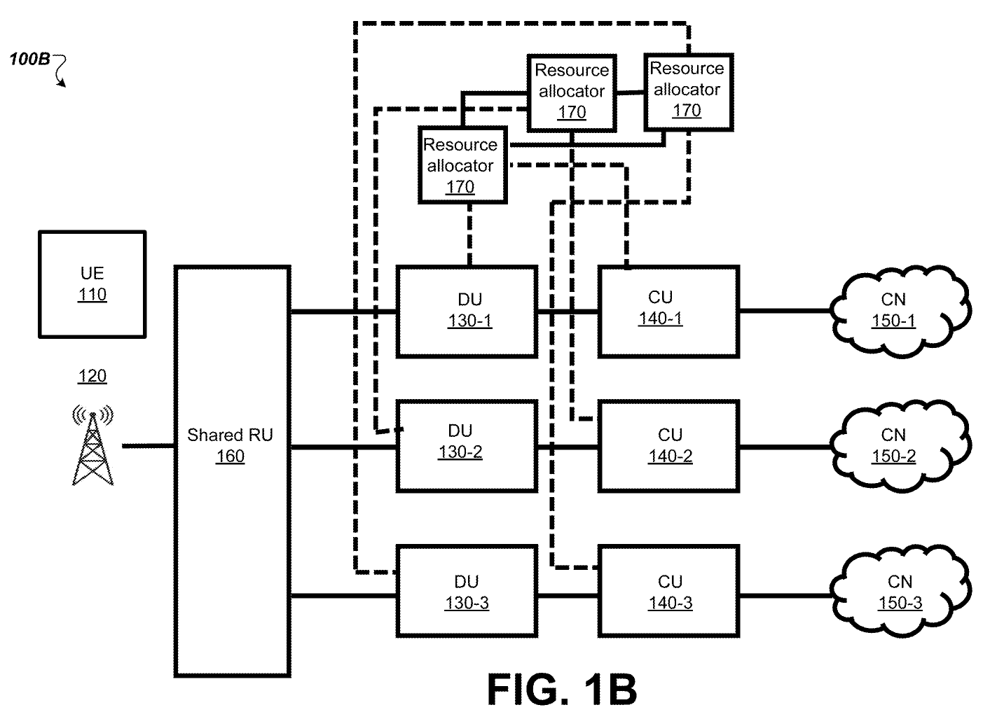

FIG. 1A is a diagram of a system 100A including a telecommunications network implementing a shared RU architecture, according to some embodiments. For example, the telecommunications network can be a cellular network (e.g., 5G wireless network, 6G wireless network). Generally, in a shared RU architecture, a host operator of the telecommunications network provides RU resources that are shared among multiple guest operators of the telecommunications network. Examples of guest operators include entities such as organizations such as corporations, enterprises, government organizations, universities, etc.

In some embodiments, the shared RU architecture is an access-on-demand (AoD) architecture. In an AoD architecture, remote (e.g., cloud) computing resources (e.g., storage, processing and/or networking resources) can be made available to a guest operator on-demand, based on the needs of the guest operator. For example, an AoD architecture can enable dynamic allocation of resources to the guest operator. Example use cases of AoD architectures include the creation of virtualized network slices (e.g., network slicing), deployment of remote computing resources closer to a guest operator (e.g., edge computing), dynamic spectrum sharing to efficiently allocate spectrum resources based on real-time demand, deployment and scaling of virtualized network functions (e.g., firewalls and load balancers), etc. Accordingly, through dynamic resource allocation, an AoD architecture can improve network performance by minimizing latency and maximizing throughput, reduce overprovisioning of unused resources to reduce cost, increase scalability based on demand to accommodate telecommunications network growth and peak usage, etc.

In some embodiments, the shared RU architecture is an Open RAN (O-RAN) architecture. An O-RAN architecture generally refers to a RAN architecture that enables seamless and secure interoperability between equipment regardless of the vendor. For example, a host operator can provide the software used to implement the network functions of the RU, while software used to implement the network functions of the distribution units (DUs), centralized units (CUs), etc. can be managed by one or more guest operators (e.g., virtualized network functions instantiated in a remote (e.g., cloud) environment).

For example, the system 100A can include user equipment (UE) 110 and radio access network (RAN) 120. The UE 110 can include an electronic device with wireless connectivity or cellular communication capability, such as a mobile phone or handheld computing device. The UE 110 can include any suitable computing device that can connect to the RAN 120 via a wireless connection. For example, the UE 110 can include a mobile computing device. As another example, the UE 110 can include a non-mobile computing device. Examples of suitable computing devices that the UE 110 can include are laptop computers, desktop computers, Internet-of-Things (IoT) devices, and/or any other computing devices that include a wireless communications interface to communicate with the RAN 120. The UE 110 can be one of a plurality of UEs (not depicted) that are in communication with the RAN 120.

The RAN 120 can implement radio access technology that can be used to enable the connection of the UE 110 to a core network of the telecommunications network (not shown in FIG. 1A). As shown in FIG. 1A, the RAN 120 can include a base station (e.g., cell site or cell tower). The base station is an element of the telecommunications network that is responsible for the transmission and reception of radio signals in one or more cells to or from UE 110. The RAN 120 can include multiple base stations that each cover a respective coverage area. In some embodiments, the base station 125 includes multiple base station components (e.g., antenna arrays), where each base station component of the base station provides coverage over a respective sector of the coverage area covered by the base station. For example, the base station can include three base station components (e.g., alpha, beta and gamma), where each base station component provides coverage over a respective 120° sector of the 360° coverage area covered by the base station. In some embodiments, the telecommunications network of the system 100A is a 5G network. For example, the UE 110 can include a 5G smartphone or a 5G cellular device that connects to the RAN 120 via a wireless connection, and the RAN 120 can include a new-generation radio access network (NG-RAN) that uses the 5G new radio interface (NR), and the base station 125 is a 5G base station (e.g., gNB). The UE 110 can gain initial access to the telecommunications network by communicating with the RAN 120 through a random access channel (RACH).

The system 100A can further include a set of distributed units (DUs), a set of centralized units (CUs), and a set of core networks (CNs). In this illustrative example, the set of DUs includes DU 130-1, DU 130-2 and DU 130-3, the set of CUs includes CU 140-1, CU 140-2 and CU 140-3, and the set of CNs includes CN 150-1, CN 150-2 and CN 150-3. Although three DUs, CUs and CNs are shown, the number of DUs should not be limiting.

A guest operator of the system 100A can manage its own network functions DU, CU, CN, etc. For example, the DU 130-1, the CU 140-1 and the CN 150-1 can be managed by a first guest operator, the DU 130-2, the CU 140-2 and the CN 150-2 can be managed by a second guest operator, and the DU 130-3, the CU 140-3 and the CN 150-3 can be managed by a third guest operator, etc. A guest operator of the system 100A can instantiate its own virtualized DU, CU, CN, etc. within a remote (e.g., cloud) environment.

In the shared RU architecture of the system 100A, the host operator can provide the shared RU 160 to be shared by the guest operators. For example, the host operator can provide spectrum, power amplifiers, filter, antennas, wiring and associated hardware to be shared by the guest operators. Each guest operator can establish a connection between its DU and the shared RU 160 via an open front-haul interface.

The system 100A can further include at least one resource allocator 170 to allocate resources, such as bandwidth, to guest operators of the system 100A. In some embodiments, the at least one resource allocator 170 is implemented by a RAN intelligent controller (RIC). In some embodiments, the at least one resource allocator 170 is shared between guest operators. In some embodiments, the at least one resource allocator 170 is not shared between guest operators. A guest operator can lease the shared RU 160 and one or more specified bandwidths from the host operator through one or more lease agreements.

The system 100A (e.g., the at least one resource allocator 170) can support a shared RU architecture with dynamic channel bandwidth allocation, in which the amount of bandwidth allocated to a guest operator is non-static. For example, the guest operator can lease access to the shared RU 160 in a particular geographical area, with a particular allocation of bandwidth during a particular period of time. The amount of bandwidth that is leased by a guest operator can be dynamically allocated accordance with various factors, such as time of day, day of the week, geographic location, as outlined in the lease agreement(s) between the host operator and the guest operator.

The amount of bandwidth allocated to a guest operator can be defined by a bandwidth zone (BWZ) that can be reserved through the host operator. A BWZ is a portion of the total channel bandwidth provided by the host operator. For example, a BWZ can be defined by a set of physical resource blocks (PRBs) that are configured within a channel bandwidth. A PRB refers to a slice of the available frequency spectrum that is allocated to carry data. Each PRB has a corresponding PRB bandwidth. Sub-carrier spacing (SCS) is the spacing in frequency between individual sub-carriers within a PRB. In some telecommunications networks (e.g., 5G), different SCS values can be used depending on the particular scenario. The total bandwidth of a BWZ allocated to the guest operator can be determined by multiplying the number of PRBs used by the PRB bandwidth of each PRB. Illustratively, a 15 kilohertz (KHz) SCS can correspond to a 180 KHz PRB bandwidth. A total bandwidth of 1.08 megahertz (MHz) can be assigned to a channel using 6 PRBs each having a bandwidth of 180 KHz. In some embodiments, a BWZ includes multiple contiguous PRBs. In some embodiments, a BWZ includes multiple non-contiguous PRBs. In some embodiments, a guest operator is allocated multiple BWZs.

There can be a maximum number of downlink BWZs and a maximum number of uplink BWZs that can be assigned to a UE (e.g., 4 downlink BWZs and uplink BWZs. However, at any time, there can be only one active downlink BWZ and one active uplink BWZ through which the UE can receive and/or transmit signals. BWZs can be specified by radio resource control (RRC) signaling. The active downlink BWZ and the active uplink BWZ can be switched among the downlink BWZs and the uplink BWZs, respectively. The switching can be performed through, e.g., RRC signaling or downlink control information (DCI). Traffic bandwidth for the guest operator can be specified by the appropriate BWZ operation.

Traffic bandwidth, corresponding to traffic channels and signals of guest operator, can be confined to the BWZ allocated to the guest operator (e.g., the traffic bandwidth does not exceed the BWZ). Traffic channels can include a downlink traffic channel and an uplink traffic channel. For example, a downlink traffic channel can be a Physical Downlink Shared Channel (PDSCH), and an uplink traffic channel can be a Physical Uplink Shared Channel (PUSCH). Accordingly, the BWZ can be allocated for the traffic bandwidth. FIG. 1B illustrates a system 100B including multiple resource allocators 170.

The at least one resource allocator 170 can support non-static TDD. More specifically, the at least one resource allocator 170 can achieve a non-static (e.g., semi-static or dynamic) DL:UL ratio for a guest operator. To do so, the at least one resource allocator 170 can divide a frequency band into multiple sub-bands, assign a respective guest operator to each sub-band, and allocate, for each sub-band assigned to the respective guest operator, a type of transmission to each time slot of the sub-band to implement TDD). For example, the type of transmission can be DL transmission or UL transmission. If a time slot of a first sub-band assigned to a first guest operator is allocated a first type of transmission (e.g., UL or DL), and a time slot of a second sub-band assigned to a second guest operator adjacent to the first the guest operator is allocated a second type of transmission different from the first type of transmission (e.g., DL or UL), then CLI between the first and second guest operators can be reduced using one or more CLI management techniques.

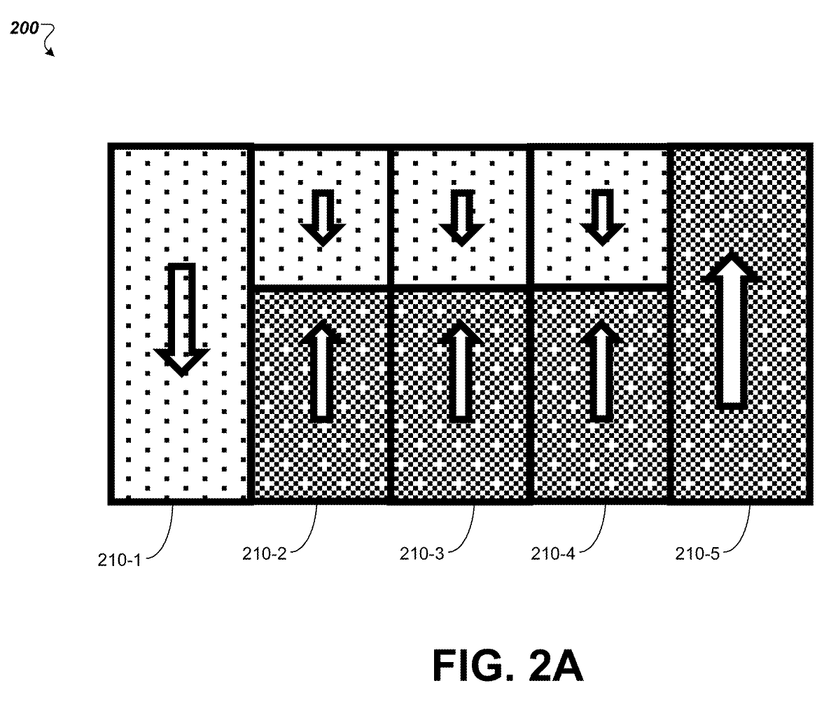

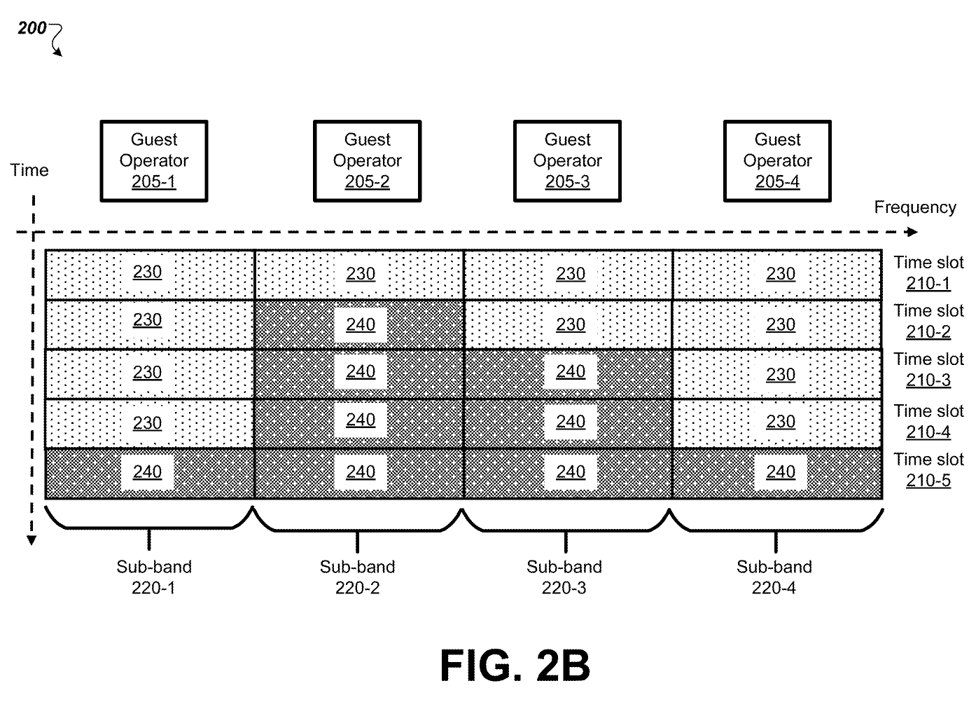

As an illustrative example of a basic CLI management technique involving signal processing, assume that the first guest operator is transmitting a signal S, and the second guest operator is receiving a signal T. Ideally, the second guest operator would receive T without any CLI. However, the second guest operator can, in practice, receive a signal T’ that is equal to the signal T modified based on S due to CLI. For example, T’ = T + kS, where k is a theoretical interference coefficient corresponding to a real number (i.e., the signal T is modified by a factor or multiple of the signal S). The value of S can be shared with the second guest operator as it is part of the same shared RU architecture. Thus, the second guest operator can determine an estimated interference coefficient k’ corresponding to an estimate of k, and use its knowledge of S to try and recover T. For example, T’ - k’S = (T + kS) - k’S = T + S (k - k’). If k ~ k’, then T’ ~ T. Other CLI management techniques can be used instead of, or in addition to, this CLI management technique. Further details regarding implementing shared RU architectures supporting non-static TDD will now be described below with reference to FIGS. 2A-5.

FIGS. 2A-2B illustrate a diagram 200 of an example implementation of a shared RU architecture supporting non-static TDD, according to some embodiments. The diagram 200 shows a plurality of time slots including time slots 210-1 through 210-5. Although five time slots are shown in this illustrative example, the number of time slots should not be considered limiting.

The diagram 200 further shows a frequency band divided into multiple sub-bands including sub-bands 220-1 through 220-4. Although four sub-bands are shown, the number of sub-bands should not be considered limiting.

The diagram 200 further shows multiple guest operators of the shared RU architecture assigned to respective sub-bands. For example, a guest operator 205-1 is assigned to the sub-band 220-1, a guest operator 205-2 is assigned to the sub-band 220-2, a guest operator 205-3 is assigned to the sub-band 220-3, and a guest operator 205-4 is assigned to the sub-band 220-4. Although four guest operators are shown in this illustrative example, the number of guest operators should not be considered limiting.

Each of the sub-bands 220-1 and 220-2 can have a flexible number of DL slots and UL slots. As shown in FIG. 2A, in this illustrative example, the time slot 210-1 is dedicated to DL transmissions across the sub-bands (as indicated by the down arrow across the frequency band), and the time slot 210-5 is dedicated to UL transmissions across the sub-bands (as indicated by the up arrow across the frequency band). As further shown in FIG. 2A, the time slots 210-2 through 210-4 are “flexible” time slots that each include a combination of UL and DL transmissions across the sub-bands.

For example, as shown in FIG. 2B, the time slot 210-1 includes only DL sub-band slots 230 across the sub-bands 220-1 through 220-4, and the time slot 210-5 includes only UL sub-band slots 240 across the sub-bands 220-1 through 220-4. Moreover, the time slots 210-2 through 210-4 each include a combination of DL sub-band slots 230 and UL sub-band slots 240.

In this illustrative example, the sub-band 220-1 (and thus the guest operator 205-1) is allocated four DL sub-band slots 230 and one UL sub-band slot 240 (i.e., the DL:UL ratio allocated to the sub-band 220-1 is 4:1). The sub-band 220-2 (and thus the guest operator 205-2) is allocated one DL sub-band slot 230 and four UL sub-band slots 240 (i.e., the DL:UL ratio allocated to the sub-band 220-2 is 1:4). The sub-band 220-3 (and thus the guest operator 205-3) is allocated two DL sub-band slots 230 and three UL sub-band slots 240 (i.e., the DL:UL ratio allocated to the sub-band 220-3 is 2:3). The sub-band 220-4 (and thus the guest operator 205-4) is allocated four DL sub-band slots 230 and one UL sub-band slot 240 (i.e., the DL:UL ratio allocated to the sub-band 220-4 is 4:1).

In some embodiments, the DL:UL ratio allocated to at least one of the sub-bands 220-1 through 220-4 is non-static (e.g., semi-static or dynamic). In this illustrative example, there may be little to no CLI between the guest operator 205-2 and the guest operator 205-3 with respect to time slots 210-1, 210-3, 210-4 and 210-5 as the adjacent sub-band slots within the sub-bands 220-2 and 220-3 are the same (either they adjacent DL sub-band slots 230 or the are adjacent UL sub-band slots 240). However, there may be CLI between guest operator 205-2 and the guest operator 205-3 with respect to time slot 210-2, as the adjacent sub-band slots within the sub-bands 220-2 and 220-3 are different (one is a DL sub-band slot 230 and the other is a UL sub-band slot 240). CLI management techniques can be used to reduce the CLI, as described above. Accordingly, the ability to use CLI management techniques can support the ability to change the DL:UL ratio allocated to at least the sub-band 220-2 or the sub-band 220-3.

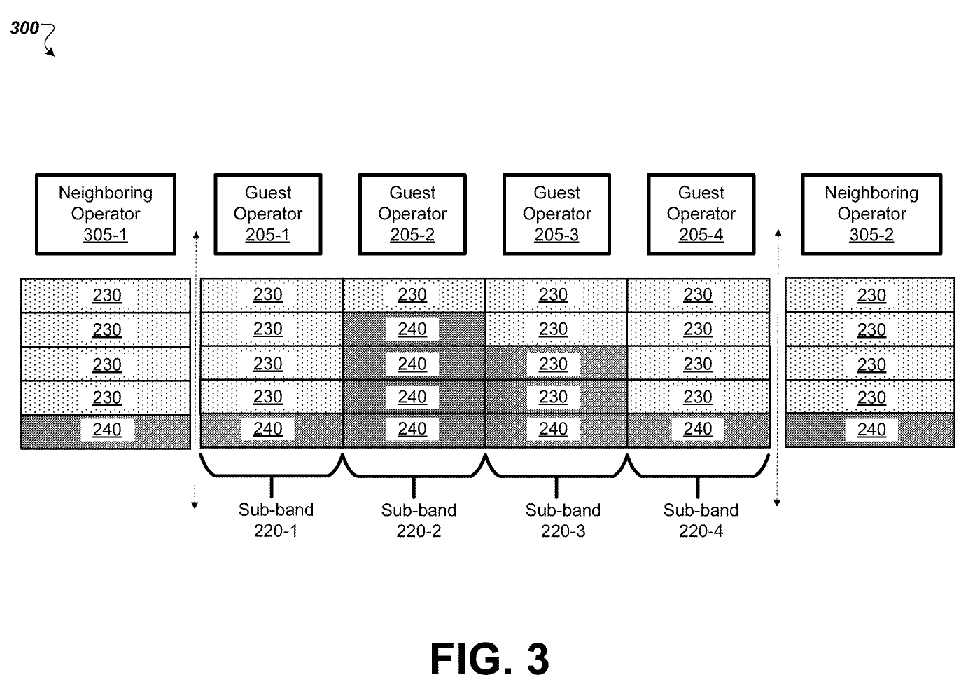

In some embodiments, at least one guest operator is adjacent to a neighboring operator of another telecommunications network different from that implementing the shared network architecture. For example, FIG. 3 is a diagram 300 an example implementation of a shared RU architecture supporting non-static TDD, according to some embodiments. The diagram 300B shows the guest operators 205-1 through 205-4, as described above with reference to FIG. 2B. The guest operators 205-1 and 205-4 are boundary (or edge) guest operators of the telecommunications network, while the guest operators 250-2 and 205-3 are non-boundary (or interior) guest operators of the telecommunications network.

The diagram 300 further shows neighboring operators 305-1 and 305-2 adjacent to the boundary guest operators 210-1 and 210-4, respectively. Each of the neighboring operators 310-5 and 310-6 is an operator of a (respective) telecommunications network different from that implementing the shared RU architecture. Although two neighboring operators are shown in this example, the number of neighboring operators should not be considered limiting.

The transmissions made by the guest operator 205-1 (e.g., DL transmissions) can interfere with the transmissions made by the neighboring operator 305-1 (e.g., UL transmissions) and the transmissions made by the guest operator 205-4 (e.g., DL transmissions) can interfere with the transmissions made by the neighboring operator 305-2 (e.g., UL transmissions). If the other telecommunications network(s) do not share information with the telecommunications network implementing the shared RU architecture that can be used to implement the one or more CLI management techniques (and vice versa), it may not be possible to allow the guest operator 205-1 or the guest operator 205-4 to implement non-static TDD (e.g., non-static DL:UL ratios). To that end, in some embodiments, the allocation of DL sub-band slots 230 and UL sub-band slots within the sub-band 220-1 is static and mirrors the allocation of DL slots 230 and UL slots 240 allocated to the neighboring operator 305-1 (e.g., the DL:UL ratio for the guest operator 205-1 is static). Similarly, in some embodiments, the allocation of DL sub-band slots 230 and UL sub-band slots within the sub-band 220-4 is static and mirrors the allocation of DL slots 230 and UL slots 240 allocated to the neighboring operator 305-2 (e.g., the DL:UL ratio for the guest operator 205-4 is static).

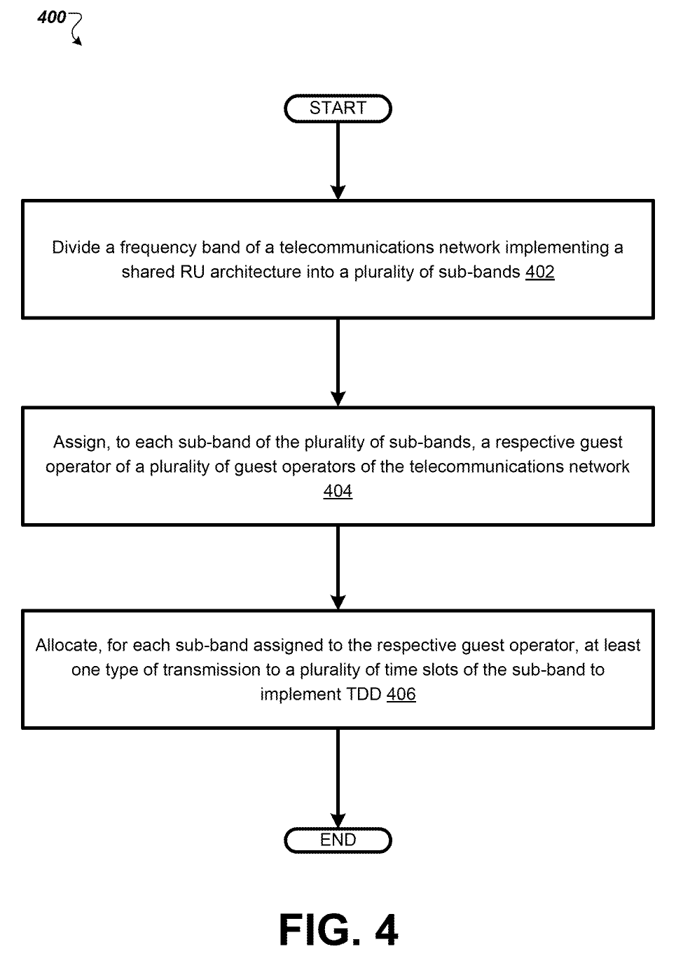

FIG. 4 is a flow diagram of a method 400 for implementing shared RU architectures supporting non-static TDD, according to some embodiments, according to some embodiments. Method 400 may be performed by processing logic that may include hardware (e.g., circuitry, dedicated logic, programmable logic, microcode, processing device, etc.), software (such as instructions run on a processing device, a general purpose computer system, or a dedicated machine), firmware, microcode, or a combination thereof. In some embodiment, method 400 may be performed, in part, by components of system 100. Method 400 may be performed by the at least one resource allocator 170 of FIGS. 1A-1B. In some embodiments, a non-transitory machine-readable storage medium stores instructions that when executed by a processing device (e.g., the at least one resource allocator 170 of FIGS. 1A-1B) cause the processing device to perform method 400. For simplicity of explanation, method 400 is depicted and described as a series of operations. However, operations in accordance with this disclosure can occur in various orders and/or concurrently and with other operations not presented and described herein. Furthermore, not all illustrated operations may be performed to implement method 400 in accordance with the disclosed subject matter. In addition, those skilled in the art will understand and appreciate that method 400 could alternatively be represented as a series of interrelated states via a state diagram or events.

At operation 402, processing logic divides a frequency band of a telecommunications network implementing a shared RU architecture into a plurality of sub-bands.

At operation 404, processing logic assigns, to each sub-band of the plurality of sub-bands, a respective guest operator of a plurality of guest operators of the telecommunications network. For example, each guest operator of the plurality of guest operators can share an RU provided by a host operator of (e.g., the shared RU 160 of FIGS. 1A-1B). Each guest operator can manage a set of virtualized components (e.g., DU and CU).

At operation 406, processing logic allocates, for each sub-band assigned to the respective guest operator, at least one type of transmission to a plurality of time slots of the sub-band to implement time division duplexing (TDD). More specifically, a type of transmission allocated to a time slot of the plurality of time slots can be an DL transmission or a UL transmission. The allocation can be made in accordance with a DL:UL ratio for the sub-band.

In some embodiments, the DL:UL ratio is non-static (e.g., semi-static or dynamic). The DL:UL ratio can be non-static in situations in which CLI can be managed by the host operator of the telecommunications network. For example, the DL:UL ratio for a sub-band can be non-static if the respective guest operator assigned to the sub-band is only adjacent to neighboring guest operators of the telecommunications network.

In some embodiments, the DL:UL ratio is static. The DL:UL ratio can be static in situations in which CLI cannot be managed by the host operator of the telecommunications network. For example, the DL:UL ratio for a sub-band can be static if the respective guest operator assigned to the sub-band is adjacent to at least one neighboring operator of at least one other telecommunications network different from the telecommunications network. In particular, the DL:UL ratio for the sub-band can be static if information for CLI management cannot be received from the one or more other telecommunications networks. For example, the DL:UL ratio for the sub-band can be the same as the DL:UL ratio for the at least one neighboring operator of the at least one other telecommunications network. Further details regarding operations 402-406 are described above with reference to FIGS. 1A-3.

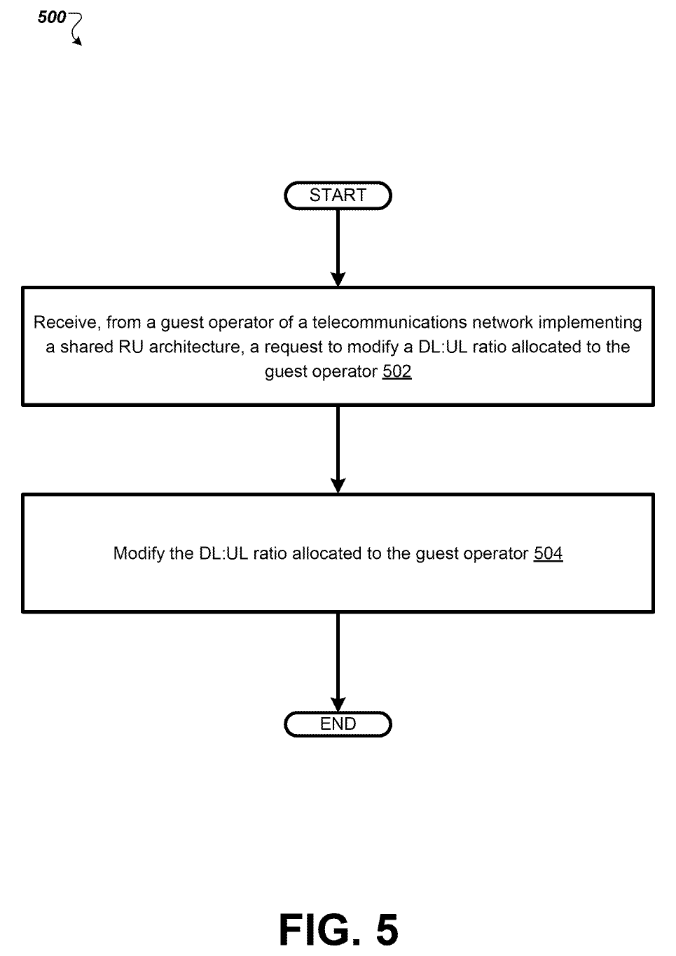

FIG. 5 is a flow diagram of a method 500 for implementing shared RU architectures supporting non-static TDD, according to some embodiments, according to some embodiments. Method 500 may be performed by processing logic that may include hardware (e.g., circuitry, dedicated logic, programmable logic, microcode, processing device, etc.), software (such as instructions run on a processing device, a general purpose computer system, or a dedicated machine), firmware, microcode, or a combination thereof. In some embodiment, method 500 may be performed, in part, by components of system 100. Method 500 may be performed by a guest operator. In some embodiments, a non-transitory machine-readable storage medium stores instructions that when executed by a processing device (e.g., the guest operator) cause the processing device to perform method 500. For simplicity of explanation, method 500 is depicted and described as a series of operations. However, operations in accordance with this disclosure can occur in various orders and/or concurrently and with other operations not presented and described herein. Furthermore, not all illustrated operations may be performed to implement method 500 in accordance with the disclosed subject matter. In addition, those skilled in the art will understand and appreciate that method 500 could alternatively be represented as a series of interrelated states via a state diagram or events.

At operation 502, processing logic receives, from a guest operator of a telecommunications network implementing a shared RU architecture, a request to modify a DL:UL ratio allocated to the guest operator. For example, the guest operator can be included in a plurality of guest operators of the telecommunications network, in which each guest operator of the plurality of guest operators can share an RU provided by a host operator of (e.g., the shared RU 160 of FIGS. 1A-1B). The guest operator can manage a set of virtualized components (e.g., DU and CU). The guest operator can be assigned a sub-band of a frequency band.

At operation 504, processing logic modifies the DL:UL ratio. For example, processing logic can change, for at least one time slot within the sub-band, a type of transmission allocated to the at least one time slot. In some embodiments, changing the type of transmission allocated to the at least one time slot includes changing a UL transmission allocated to a time slot to a DL transmission. In some embodiments, changing the type of transmission allocated to the at least one time slot includes changing a DL transmission allocated to a time slot to a UL transmission. Further details regarding operations 502 and 504 are described above with reference to FIGS. 1A-4.

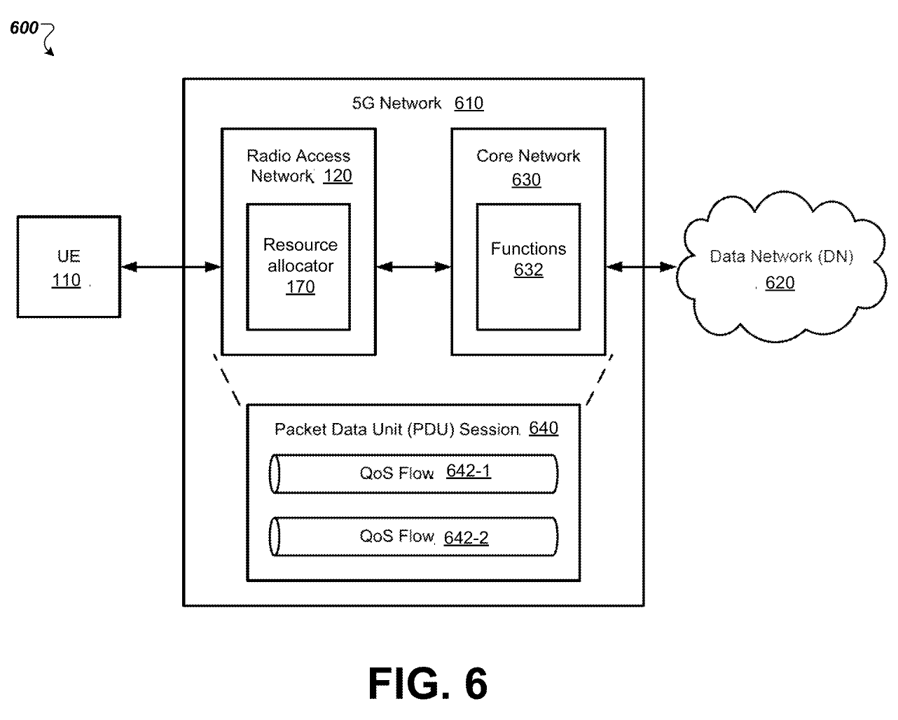

FIG. 6 depicts a 5G network 610 including the RAN 120 and a core network 630 according to at least one embodiment. The RAN 120 can be similar to the RAN 120 of FIGS. 1A-1B. The RAN 120 can include a new-generation radio access network (NG-RAN) that uses the 5G new radio interface (NR). The 5G network 610 connects the UE 110 to a data network (DN) 620 using the RAN 120 and a core network 630. The DN 620 can include the Internet, a local area network (LAN), a wide area network (WAN), a private data network, a wireless network, a wired network, or a combination of networks. The UE 110 can include an electronic device with wireless connectivity or cellular communication capability, such as a mobile phone or handheld computing device. In at least one example, the UE 110 can include a 5G smartphone or a 5G cellular device that connects to the RAN 120 via a wireless connection.

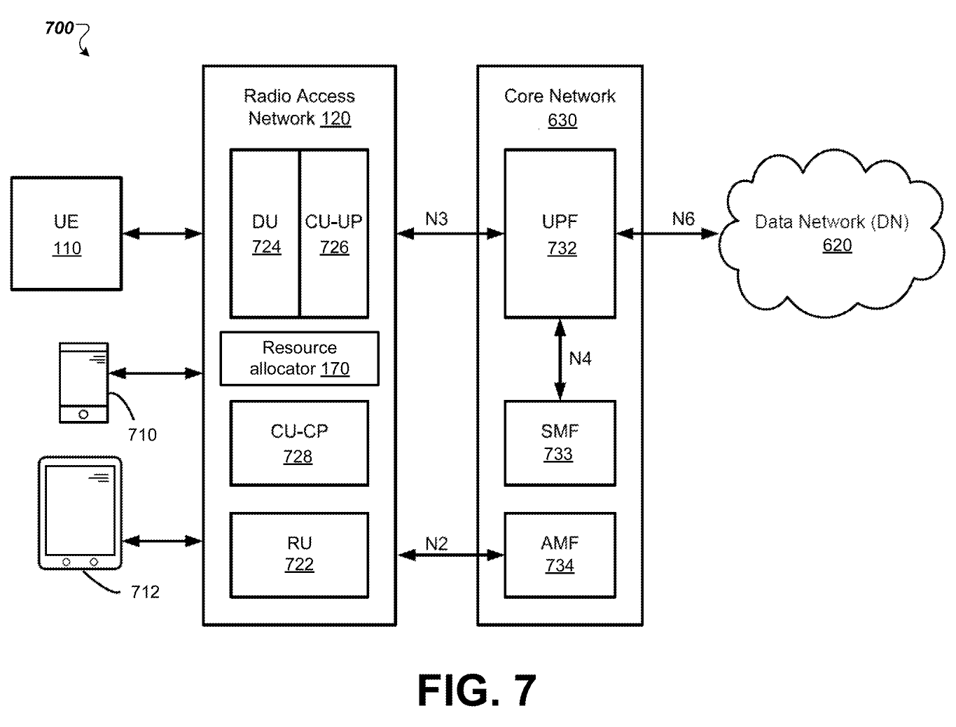

The RAN 120 may include at least one base station (e.g., the base station 125 of FIGS. 1A-1B) that connects the UE 110 to the core network 630. In some embodiments, and as shown in FIG. 6, the at least one resource allocator 170 can be included in the RAN 120. As will be described in further detail below with reference to FIG. 7, the RAN 120 can include at least one radio unit (RU) for wirelessly communicating with the UE 110. An RU can include one or more radio transceivers for wirelessly communicating with UE 110. The at least one RU may include circuitry for converting signals sent to and from an antenna of the base station into digital signals for transmission over packet networks.

The core network 630 may utilize a cloud-native service-based architecture (SBA) in which different core network functions (e.g., authentication, security, session management, and core access and mobility functions) are virtualized and implemented as loosely coupled independent services that communicate with each other, for example, using hypertext transfer protocol (HTTP) (e.g., HTTP2) and application programming interfaces (APIs). In at least one embodiment, an architecture in which software is composed of small independent services that communicate over well-defined APIs may be used for implementing some of the core network functions. For example, control plane (CP) network functions for performing session management may be implemented as containerized applications. A container-based embodiment may offer improved scalability and availability over other approaches.

Core network functions (“functions”) 632 of core network can include an access and mobility management function (AMF), a session management function (SMF), and a user plane function (UPF). In at least one embodiment, the intelligent data collector can be implemented in the AMF. The UPF may perform packet processing including routing and forwarding, quality of service (QoS) handling, and packet data unit (PDU) session management. The UPF may serve as an ingress and egress point for user plane traffic and provide anchored mobility support for user equipment. For example, the UPF may provide an anchor point between the UE 110 and the DN 620 as the UE 110 moves between coverage areas. The AMF may act as a single-entry point for UE connection and perform mobility management, registration management, and connection management between a data network and the UE 110. The SMF may perform session management, user plane selection, and internet protocol (IP) address allocation. Functions 632 can include a network repository function (NRF) for maintaining a list of available network functions and providing network function service registration and discovery, a policy control function (PCF) for enforcing policy rules for control plane functions, an authentication server function (AUSF) for authenticating user equipment and handling authentication related functionality, a network slice selection function (NSSF) for selecting network slice instances, and an application function (AF) for providing application services. Application-level session information may be exchanged between the AF and PCF (e.g., bandwidth requirements for QoS). In some cases, when user equipment requests access to resources, such as establishing a PDU session or a QoS flow, the PCF may dynamically decide if the user equipment should grant the requested access based on a location of the user equipment. Further details regarding the functions 632 will be described below with reference to FIG. 7.

The 5G network 610 may provide one or more network slices, where each network slice may include a set of network functions that are selected to provide telecommunications services. For example, each network slice can include a configuration of network functions, network applications, and underlying cloud-based compute and storage infrastructure. In some cases, a network slice may correspond with a logical instantiation of a 5G network, such as an instantiation of the 5G network 610. In some cases, the 5G network 610 may support customized policy configuration and enforcement between network slices per service level agreements (SLAs) within the RAN 120. User equipment, such as UE 110, may connect to multiple network slices at the same time (e.g., eight different network slices). In one embodiment, a PDU session, such as PDU session 640, may belong to only one network slice instance.

A network slice can include an independent end-to-end logical communications network that includes a set of logically separated virtual network functions. Network slicing may allow different logical networks or network slices to be implemented using the same compute and storage infrastructure. Therefore, network slicing may allow heterogeneous services to coexist within the same network architecture via allocation of network computing, storage, and communication resources among active services. In some cases, the network slices may be dynamically created and adjusted over time based on network requirements. For example, some networks may require ultra-low-latency or ultra-reliable services. To meet ultra-low-latency requirements, components of the RAN 120, such as a distributed unit (DU) and a centralized unit (CU), may need to be deployed at a base station or in a local data center (LDC) that is in close proximity to a base station such that the latency requirements are satisfied (e.g., such that the one-way latency from the base station to the DU component or CU component is less than 1.2 milliseconds (ms)). In some embodiments, the DU and the CU of the RAN 120 may be co-located with the RU. In other embodiments, the DU and the RU may be co-located at a base station and the CU may be located within a local data center (LDC).

In some cases, the 5G network 610 may dynamically generate network slices to provide telecommunications services for various use cases, such the enhanced Mobile Broadband (eMBB), Ultra-Reliable and Low-Latency Communication (URLCC), and massive Machine Type Communication (mMTC) use cases.

A cloud-based compute and storage infrastructure can include a networked computing environment that provides a cloud computing environment. Cloud computing may refer to Internet-based computing, where shared resources, software, and/or information may be provided to one or more computing devices on-demand via the Internet (or other network). The term “cloud” may be used as a metaphor for the Internet, based on the cloud drawings used in computer networking diagrams to depict the Internet as an abstraction of the underlying infrastructure it represents.

The core network 630 may include a set of network elements that are configured to offer various data and telecommunications services to subscribers or end users of user equipment, such as UE 110. Examples of network elements include network computers, network processors, networking hardware, networking equipment, routers, switches, hubs, bridges, radio network controllers, gateways, servers, virtualized network functions and/or containerized network functions, and network functions infrastructure (e.g., virtualization or containerization infrastructure). A network element can include a real or virtualized or containerized component that provides wired or wireless communication network services.

Virtualization allows virtual hardware to be created and decoupled from the underlying physical hardware. One example of a virtualized component is a virtual router (or a vRouter). Another example of a virtualized component is a virtual machine. A virtual machine can include a software embodiment of a physical machine. The virtual machine may include one or more virtual hardware devices, such as a virtual processor, a virtual memory, a virtual disk, or a virtual network interface card. The virtual machine may load and execute an operating system and applications from the virtual memory. The operating system and applications used by the virtual machine may be stored using the virtual disk. The virtual machine may be stored as a set of files including a virtual disk file for storing the contents of a virtual disk and a virtual machine configuration file for storing configuration settings for the virtual machine. The configuration settings may include the number of virtual processors (e.g., four virtual CPUs), the size of a virtual memory, and the size of a virtual disk (e.g., a 64GB virtual disk) for the virtual machine. Another example of a virtualized component is a software container or an application container that encapsulates an application’s environment.

In some embodiments, applications and services may be run using virtual machines instead of containers in order to improve security. A common virtual machine may also be used to run applications and/or containers for a number of closely related network services.

The 5G network 610 may implement various network functions, such as the functions 632 and radio access network functions, using a cloud-based compute and storage infrastructure. A network function may be implemented as a software instance running on hardware or as a virtualized network function. Virtual network functions (VNFs) can include embodiments of network functions as software processes or applications. In at least one example, a virtual network function (VNF) may be implemented as a software process or application that is run using virtual machines (VMs) or application containers within the cloud-based compute and storage infrastructure. Application containers (or containers) allow applications to be bundled with their own libraries and configuration files, and then executed in isolation on a single operating system (OS) kernel. Application containerization may refer to an OS-level virtualization method that allows isolated applications to be run on a single host and access the same OS kernel. Containers may run on bare-metal systems, cloud instances, and virtual machines. Network functions virtualization may be used to virtualize network functions, for example, via virtual machines, containers, and/or virtual hardware that runs processor readable code or executable instructions stored in one or more computer-readable storage mediums (e.g., one or more data storage devices).

The 5G network 610 may connect the UE 110 to the DN 620 using a PDU session 640, which can include part of an overlay network. The PDU session 640 may utilize one or more quality of service (QoS) flows, such as QoS flows 642-1 and 642-2, to exchange traffic (e.g., data and voice traffic) between the UE 110 and the DN 620. The one or more QoS flows can include the finest granularity of QoS differentiation within the PDU session 640. The PDU session 640 may belong to a network slice instance through the 5G network 610. To establish user plane connectivity from the UE 110 to the DN 620, an AMF that supports the network slice instance may be selected and a PDU session via the network slice instance may be established. In some cases, the PDU session 640 may be of type IPv4 or IPv6 for transporting IP packets. The RAN 120 may be configured to establish and release parts of the PDU session 640 that cross the radio interface.

The RAN 120 may include a set of one or more RUs that includes radio transceivers (or combinations of radio transmitters and receivers) for wirelessly communicating with UEs. The set of RUs may correspond with a network of cells (or coverage areas) that provide continuous or nearly continuous overlapping service to UEs, such as UE 110, over a geographic area. Some cells may correspond with stationary coverage areas and other cells may correspond with coverage areas that change over time (e.g., due to movement of a mobile RU). In some cases, the UE 110 may be capable of transmitting signals to and receiving signals from one or more RUs within the network of cells over time. One or more cells may correspond with a base station. The cells within the network of cells may be configured to facilitate communication between the UE 110 and other UEs and/or between the UE 110 and a data network, such as the DN 620. The cells may include macrocells (e.g., capable of reaching 18 miles) and small cells, such as microcells (e.g., capable of reaching 1.2 miles), picocells (e.g., capable of reaching 0.12 miles), and femtocells (e.g., capable of reaching 32 feet). Small cells may communicate through macrocells. Although the range of small cells may be limited, small cells may enable mmWave frequencies with high-speed connectivity to UEs within a short distance of the small cells. Macrocells may transit and receive radio signals using multiple-input multiple-output (MIMO) antennas that may be connected to a cell tower, an antenna mast, or a raised structure.

The UPF may be responsible for routing and forwarding user plane packets between the RAN 120 and the DN 620. Uplink packets arriving from the RAN 120 may use a general packet radio service (GPRS) tunneling protocol (or GTP) to reach the UPF. The GPRS tunneling protocol for the user plane may support multiplexing of traffic from different PDU sessions by tunneling user data over the interface between the RAN 120 and the UPF.

The UPF may remove the packet headers belonging to the GTP tunnel before forwarding the user plane packets towards the DN 620. As the UPF may provide connectivity towards other data networks in addition to the DN 620, the UPF must ensure that the user plane packets are forwarded towards the correct data network. Each GTP tunnel may belong to the PDU session 640. The PDU session 640 may be set up towards a data network name (DNN) that uniquely identifies the data network to which the user plane packets should be forwarded. The UPF may keep a record of the mapping between the GTP tunnel, the PDU session, and the DNN for the data network to which the user plane packets are directed.

Downlink packets arriving from the DN 620 can be mapped onto at least one quality of service (QoS) flow belonging to the PDU session 640 before forwarded towards the appropriate RAN 120. A QoS flow may correspond with a stream of data packets that have equal QoS. In some embodiments, and as sown in FIG. 6, multiple QoS flows including QoS flow 642-1 and 642-2 can belong to the PDU session 640. The UPF may use a set of service data flow (SDF) templates to map each downlink packet onto a respective QoS flow. The UPF may receive the set of SDF templates from a session management function (SMF), such as the SMF, during setup of the PDU session 640. The SMF may generate the set of SDF templates using information provided from a policy control function (PCF), such as the PCF. The UPF may track various statistics regarding the volume of data transferred by each PDU session, such as the PDU session 640, and provide the information to an SMF.

FIG. 7 depicts a RAN 120 and a core network 630 for providing a communications channel (or channel) between user equipment and DN 620 according to at least one embodiment. In at least one embodiment, the at least one resource allocator 170 can be implemented in the RAN 120. The communications channel can include a pathway through which data is communicated between the UE 110 and the DN 620. The UE in communication with the RAN 120 includes the UE 110, a mobile phone 710, and a mobile computing device 712. The UE may include a set of electronic devices, including mobile computing device and non-mobile computing device.

The core network 630 includes core network functions such as UPF 732, SMF 733 and AMF 734, as described above with reference to FIG. 6. For example, the AMF 734 may interface with user equipment and act as a single-entry point for a UE connection. The AMF 734 may interface with the SMF to track user sessions. The AMF 734 may interface with a network slice selection function (NSSF) not depicted to select network slice instances for user equipment, such as UE 110. When user equipment is leaving a first coverage area and entering a second coverage area, the AMF 734 may be responsible for coordinating the handoff between the coverage areas whether the coverage areas are associated with the same radio access network or different radio access networks.

The UPF 732 may transfer downlink data received from the DN 620 to user equipment, such as UE 110, via the RAN 120 and/or transfer uplink data received from user equipment to the DN 620 via the RAN 120. An uplink can include a radio link though which user equipment transmits data and/or control signals to the RAN 120. A downlink can include a radio link through which the RAN 120 transmits data and/or control signals to the user equipment.

The RAN 120 may be logically divided into an RU 722, a DU 724, and a CU that is partitioned into a CU user plane portion (CU-UP) 726 and a CU control plane portion (CU-CP) 728. The CU-UP 726 may correspond with the centralized unit for the user plane and the CU-CP 728 may correspond with the centralized unit for the control plane. The CU-UP 726 may perform functions related to a user plane, such as user data transmission and reception functions. The CU-CP 728 may perform functions related to a control plane, such as connection setup, mobility, and security.

Decoupling control signaling in the control plane from user plane traffic in the user plane may allow the UPF 732 to be positioned in close proximity to the edge of a network compared with the AMF 734. In at least one embodiment, the intelligent data collector 106 can be implemented in the AMF 734. As a closer geographic or topographic proximity may reduce the electrical distance, this means that the electrical distance from the UPF 732 to the UE 110 may be less than the electrical distance of the AMF 734 to the UE 110. The RAN 120 may be connected to the AMF 734, which may allocate temporary unique identifiers, determine tracking areas, and select appropriate policy control functions (PCFs) for user equipment, via an N2 interface. The N3 Interface may be used for transferring user data (e.g., user plane traffic) from the RAN 120 to the user plane function UPF 732 and may be used for providing low-latency services using edge computing resources. The electrical distance from the UPF 732 (e.g., located at the edge of a network) to user equipment, such as UE 110, may impact the latency and performance services provided to the user equipment. The UE 110 may be connected to the SMF 733 via an N1 interface not depicted, which may transfer UE information directly to the AMF 734. The UPF 732 may be connected to the DN 620 via an N6 interface. The N6 interface may be used for providing connectivity between the UPF 732 and other external or internal data networks (e.g., to the Internet). The RAN 120 may be connected to the SMF 733, which may manage UE context and network handovers between Base Stations, via the N2 interface. The N2 interface may be used for transferring control plane signaling between the RAN 120 and the AMF 734.

The RU 722 may perform physical layer functions, such as employing orthogonal frequency-division multiplexing (OFDM) for downlink data transmission. In some cases, the DU 724 may be located at a base station (or a cellular Base Station) and may provide real-time support for lower layers of the protocol stack, such as the radio link control (RLC) layer and the medium access control (MAC) layer. The CU may provide support for higher layers of the protocol stack, such as the service data adaptation protocol (SDAP) layer, the packet data convergence control (PDCP) layer, and the radio resource control (RRC) layer. The SDAP layer can include the highest L2 sublayer in the 5G NR protocol stack. In some embodiments, a radio access network may correspond with a single CU that connects to multiple DUs (e.g., 10 DUs), and each DU may connect to multiple RRUs (e.g., 18 RRUs). In this case, a single CU may manage 10 different base stations and 180 different RRUs.

In some embodiments, the RAN 120 or portions of the RAN 120 may be implemented using multi-access edge computing (MEC) that allows computing and storage resources to be moved closer to user equipment. Allowing data to be processed and stored at the edge of a network that is located close to the user equipment may be necessary to satisfy low-latency application requirements. In at least one example, the DU 724 and CU-UP 726 may be executed as virtual instances within a data center environment that provides single-digit millisecond latencies (e.g., less than 2ms) from the virtual instances to the UE 110.

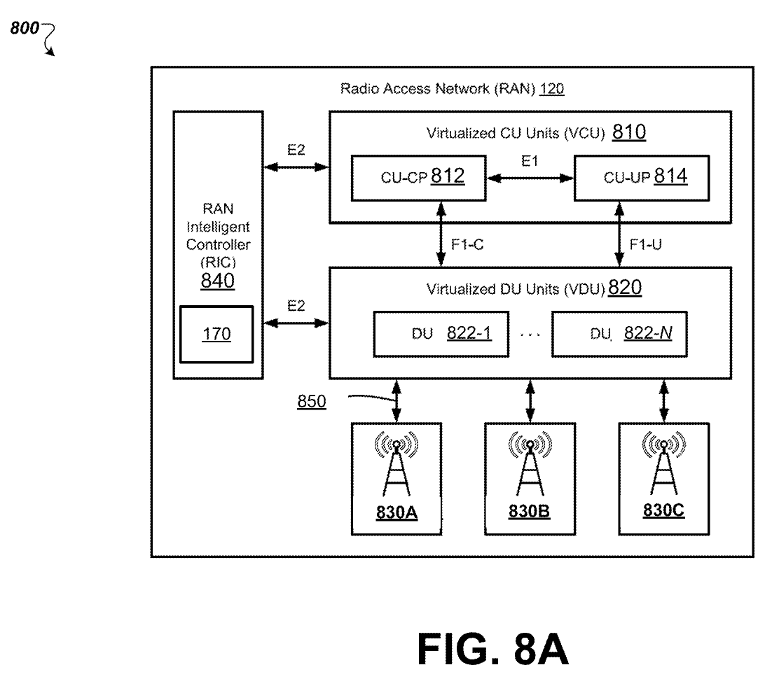

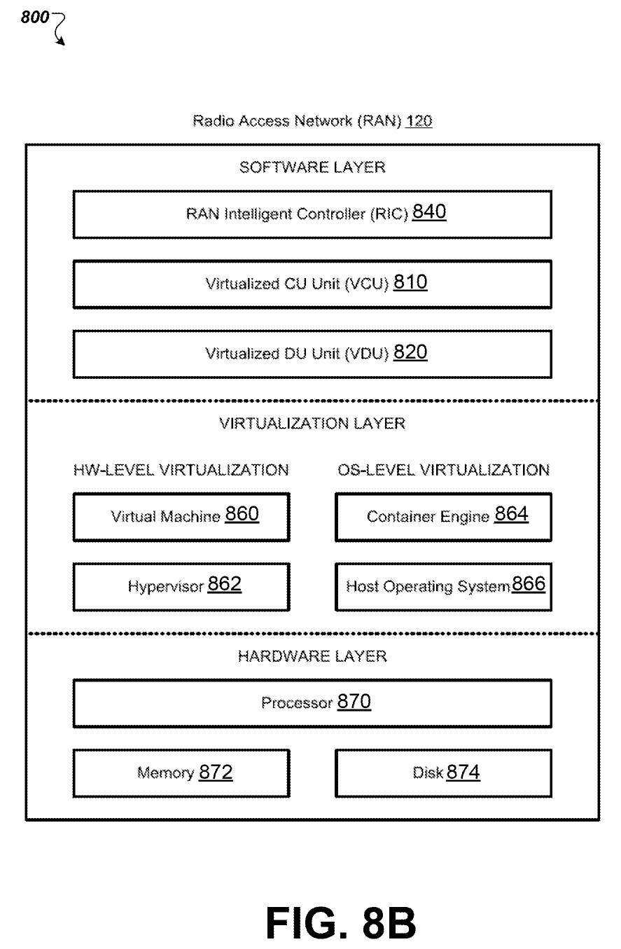

FIG. 8A depicts a system 800 including the RAN 120, according to some embodiments. For example, the RAN 120 can include virtualized CU units (VCU) 810. The VCU 810 can include virtualized versions (or containerized versions) of CUs, including a CU-CP 812 and a CU-UP 814. In one example, CUs can include a logical node configured to provide functions for the radio resource control (RRC) layer, the packet data convergence control (PDCP) layer, and the service data adaptation protocol (SDAP) layer. The CU-CP 812 can include a logical node configured to provide functions of the control plane part of the RRC and PDCP. The CU-UP 814 can include a logical node configured to provide functions of the user plane part of the SDAP and PDCP. Virtualizing the control plane and user plane functions allows the CUs to be consolidated in one or more data centers on RAN-based open interfaces.

As another example, the RAN 120 can include virtualized DU units (VDU) 820. The VDU 820 can include virtualized versions (or containerized versions) of DUs 822-1 through 822-N. Each of the DUs 822-1 through 822-N can include a logical node configured to provide functions for the radio link control (RLC) layer, the medium access control (MAC) layer, and the physical layer (PHY) layers. For example, a higher physical layer (H-PHY) can reside at the DUs and a lower physical layer (L-PHY) can reside at the RU.

In some embodiments, and as shown in FIG. 8A, the at least one resource allocator 170 can be implemented in the RIC 840, as described herein. In some embodiments, the at least one resource allocator 170 can be implemented in the VCU 810.

RUs 830A-830C may correspond with different base stations. A single DU may connect to multiple RUs via a fronthaul interface 850. The fronthaul interface 850 may provide connectivity between DUs and RUs. For example, DU 830A may connect to 18 RUs via the fronthaul interface 850. CUs may control the operation of multiple DUs via a midhaul F1 Interface that includes the F1-C and F1-U interfaces. The F1 Interface may support control plane and user plane separation, and separate the Radio Network Layer and the Transport Network Layer. In one example, the CU-CP 812 may connect to ten different DUs within the virtualized DU units 1210. In this case, the CU-CP 812 may control ten DUs and 180 RUs. A single one of DUs 822-1 through 822-N may be located at a base station or in a local data center. Centralizing a single DU at a local data center or at a single base station location instead of distributing the single DU 1204 across multiple base stations may result in reduced costs.

The CU-CP 812 may host the radio resource control (RRC) layer and the control plane part of the packet data convergence control (PDCP) layer. The E1 Interface may separate the Radio Network Layer and the Transport Network Layer. The CU-CP 812 terminates the E1 Interface connected with the centralized unit for the user plane CU-UP 814 and the F1-C interface connected with the DUs 822-1 through 822-N. The CU-UP 814 hosts the user plane part of the PDCP layer and a service data adaptation protocol (SDAP) layer. The CU-UP 814 terminates the E1 Interface connected with the centralized unit for the CU-CP 812 and the F1-U interface connected with the DUs 822-1 through 822-N. The DUs 822-1 through 822-N may handle the lower layers of the baseband processing up through the PDCP layer of the protocol stack. The interfaces F1-C and E1 may carry signaling information for setting up, modifying, relocating, and/or releasing a UE context.

The RIC 840 may control the underlying RAN elements via the E2 Interface. The E2 Interface connects the RIC 840 to the DUs 822-1 through 822-N and the centralized units including CU-CP 812 and CU-UP 814. The RIC 840 can include a real time or near-real time RIC (RT-RIC) or a non-real-time RIC (NRT-RIC). An NRT-RIC can include a logical node allowing non-real time control rather than near-real-time control and an RT-RIC can include a logical node allowing near-real-time control and optimization of RAN elements and resources on the bases of information collected from the DUs 822-1 through 822-N and the centralized units including CU-CP 812 and CU-UP 814 via the E2 Interface.

The virtualization or containerization of the DUs 822-1 through 822-N and the centralized units including CU-CP 812 and CU-UP 814 allows various deployment options that may be adjusted over time based on network conditions and network slice requirements. In at least one example, both a DU and a corresponding centralized unit may be implemented at a base station. In another example, at least one DUs 822-1 through 822-N may be implemented at a base station and the corresponding CU-UP 814 may be implemented at a local data center (LDC). In another example, at least one DUs 822-1 through 822-N and the corresponding CU-UP 814 may be implemented at an LDC. In another example, at least one DUs 822-1 through 822-N and the corresponding CU-UP 814 may be implemented at a base station, but the corresponding the CU-CP 812 may be implemented at an LDC. In another example, at least one DUs 822-1 through 822-N may be implemented at an LDC and the corresponding CU-CP 812 and CU-UP 814 may be implemented at an EDC.

In some embodiments, network slicing operations may be communicated via the E1, F1-C, and F1-U interfaces of the RAN 120. For example, CU-CP 812 may select the appropriate DU and CU-UP 814 entities to serve a network slicing request associated with a particular service level agreement (SLA).

FIG. 8B depicts a system 800 including the RAN 120, according to some embodiments. As depicted, the RAN 120 includes a software layer, a virtualization layer and a hardware layer. The software layer can include software applications, such as RIC 840, VCU 810, and VDU 820.

The virtualization layer can include at least one virtual machine 860, a hypervisor 862, container engine 864, and a host operating system 866. The hypervisor 862 can include a native hypervisor (or bare-metal hypervisor) or a hosted hypervisor (or type 2 hypervisor). The hypervisor 862 may provide a virtual operating platform for running at least one virtual machine 860. The hypervisor 862 can include software that creates and runs virtual machine instances. The at least one virtual machine 860 may include a set of virtual hardware devices, such as a virtual processor, a virtual memory, and a virtual disk. The at least one virtual machine 860 may include a guest operating system that has the capability to run one or more software applications, such as the RIC 840. The at least one virtual machine 860 may run the host operating system 866 upon which the container engine 864 may run. At least one virtual machine 860 may include one or more virtual processors. The container engine 864 may run on top of the host operating system 866 in order to run multiple isolated instances (or containers) on the same operating system kernel of the host operating system 866. Containers may perform virtualization at the operating system level and may provide a virtualized environment for running applications and their dependencies. The container engine 864 may acquire a container image and convert the container image into running processes. In some cases, the container engine 864 may group containers that make up an application into logical units (or pods). A pod may contain one or more containers and all containers in a pod may run on the same node in a cluster. Each pod may serve as a deployment unit for the cluster. Each pod may run a single instance of an application.

In order to scale an application horizontally, multiple instances of a pod may be run in parallel. A "replica" may refer to a unit of replication employed by a computing platform to provision or deprovision resources. Some computing platforms may run containers directly and therefore a container can include the unit of replication. Other computing platforms may wrap one or more containers into a pod and therefore a pod can include the unit of replication.

A replication controller may be used to ensure that a specified number of replicas of a pod are running at the same time. If less than the specified number of pods are running (e.g., due to a node failure or pod termination), then the replication controller may automatically replace a failed pod with a new pod. In some cases, the number of replicas may be dynamically adjusted based on a prior number of node failures. For example, if it is detected that a prior number of node failures for nodes in a cluster running a particular network slice has exceeded a threshold number of node failures, then the specified number of replicas may be increased (e.g., increased by one). Running multiple pod instances and keeping the specified number of replicas constant may prevent users from losing access to their application in the event that a particular pod fails or becomes inaccessible.

In some embodiments, a virtualized infrastructure manager not depicted may run on the RAN 120 in order to provide a centralized platform for managing a virtualized infrastructure for deploying various components of the RAN 120. The virtualized infrastructure manager may manage the provisioning of virtual machines, containers, and pods. The virtualized infrastructure manager may also manage a replication controller responsible for managing a number of pods. In some cases, the virtualized infrastructure manager may perform various virtualized infrastructure related tasks, such as cloning virtual machines, creating new virtual machines, monitoring the state of virtual machines, and facilitating backups of virtual machines.

The hardware-level components include at least one processor 870, at least one memory 872 operatively coupled with the at least one processor 870, and at least one disk 874. The at least one memory 872 can have stored therein processor-readable instructions when, when executed by the at least one processor 870, causes the at least one processor 870 to perform operations described herein. The components of the software layer may be run using the components of the hardware layer or executed using processor and storage components of the hardware layer. In some examples, at least one of the RIC 840, VCU 810, or VDU 820 may be run using the at least one processor 870, the at least one memory 872, and the at least one disk 874. In another example, at least one of the RIC 840, VCU 810, or VDU 820 may be run using a virtual processor and a virtual memory that are themselves executed or generated using the at least one processor 870, the at least one memory 872, and the at least one disk 874.

The at least one processor 870 may include one or more processing units, such as one or more CPUs and/or one or more graphics processing units (GPUs). The at least one memory 872 can include one or more types of memory (e.g., random-access memory (RAM), static RAM (SRAM), dynamic RAM (DRAM), read-only memory (ROM), electrically erasable programmable read-only memory (EEPROM), or flash memory). The at least one disk 874 can include a hard disk drive and/or a solid-state drive.

In the above description, numerous details are set forth. It will be apparent, however, to one of ordinary skill in the art having the benefit of this disclosure, that embodiments may be practiced without these specific details. In some instances, well-known structures and devices are shown in block diagram form rather than in detail in order to avoid obscuring the description.

Some portions of the detailed description are presented in terms of algorithms and symbolic representations of operations on data bits within a computer memory. These algorithmic descriptions and representations are the means used by those skilled in the data processing arts to convey the substance of their work most effectively to others skilled in the art. An algorithm is used herein and is generally conceived to be a self-consistent sequence of steps leading to the desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “receiving,” determining,” “allocating,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Embodiments also relate to an apparatus for performing the operations herein. This apparatus may be specially constructed for the required purposes, or it may comprise a general-purpose computer selectively activated or reconfigured by a computer program stored in the computer. Such a computer program may be stored in a computer-readable storage medium, such as, but not limited to, any type of disk including floppy disks, optical disks, Read-Only Memories (ROMs), compact disc ROMs (CD-ROMs), and magnetic-optical disks, Random Access Memories (RAMs), EPROMs, EEPROMs, magnetic or optical cards, or any type of media suitable for storing electronic instructions. One or more non-transitory, computer-readable storage media can have computer-readable instructions stored thereon which, when executed by one or more processing devices, cause the one or more processing devices to perform the operations described herein.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the present embodiments are not described with reference to any particular programming language. It will be appreciated that a variety of programming languages may be used to implement the teachings of the present embodiments as described herein. It should also be noted that the terms “when” or the phrase “in response to,” as used herein, should be understood to indicate that there may be intervening time, intervening events, or both before the identified operation is performed.

It is to be understood that the above description is intended to be illustrative, and not restrictive. Many other embodiments will be apparent to those of skill in the art upon reading and understanding the above description. The scope of the present embodiments should, therefore, be determined with reference to the appended claims, along with the full scope of equivalents to which such claims are entitled.

What is claimed is:

1. A method comprising:
receiving, from a guest operator assigned to a sub-band of a frequency band of a telecommunications network implementing a shared radio unit architecture, a request to modify a downlink to uplink ratio associated with the sub-band to implement time division duplexing; and
modifying the downlink to uplink ratio.

2. The method of claim 1, wherein the sub-band comprises a plurality of time slots, and wherein the plurality of time slots is allocated at least one type of transmission.

3. The method of claim 2, wherein the at least one type of transmission is at least one of an uplink transmission or a downlink transmission.

4. The method of claim 1, wherein the guest operator is not a boundary guest operator of the telecommunications network.

5. The method of claim 1, further comprising:
dividing the frequency band into a plurality of sub-bands comprising the sub-band;
assigning, to each sub-band of the plurality of sub-bands, a respective guest operator of a plurality of guest operator of the telecommunications network; and
allocating, for each sub-band assigned to the respective guest operator, at least one type of transmission to a plurality of time slots of the sub-band.

6. The method of claim 1, wherein a second downlink to uplink ratio associated with a second guest operator assigned to a second sub-band of the frequency band is static.

7. The method of claim 6, wherein the second guest operator is a boundary guest operator of the telecommunications network.

8. A system comprising:
a memory; and
a processing device, operatively coupled with the memory, to:
receive, from a guest operator assigned to a sub-band of a frequency band of a telecommunications network implementing a shared radio unit architecture, a request to modify a downlink to uplink ratio associated with the sub-band to implement time division duplexing; and
modify the downlink to uplink ratio.

9. The system of claim 8, wherein the sub-band comprises a plurality of time slots, and wherein the plurality of time slots is allocated at least one type of transmission.

10. The system of claim 9, wherein the at least one type of transmission is at least one of an uplink transmission or a downlink transmission.

11. The system of claim 8, wherein the guest operator is not a boundary guest operator of the telecommunications network.

12. The system of claim 8, further comprising:
dividing the frequency band into a plurality of sub-bands comprising the sub-band;
assigning, to each sub-band of the plurality of sub-bands, a respective guest operator of a plurality of guest operator of the telecommunications network; and
allocating, for each sub-band assigned to the respective guest operator, at least one type of transmission to a plurality of time slots of the sub-band.

13. The system of claim 8, wherein a second downlink to uplink ratio associated with a second guest operator assigned to a second sub-band of the frequency band is static.

14. The system of claim 13, wherein the second guest operator is a boundary guest operator of the telecommunications network.

15. A non-transitory computer-readable storage medium comprising instructions that, when executed by a processing device, cause the processing device to perform operations comprising:
receiving, from a guest operator assigned to a sub-band of a frequency band of a telecommunications network implementing a shared radio unit architecture, a request to modify a downlink to uplink ratio associated with the sub-band to implement time division duplexing; and
modifying the downlink to uplink ratio.

16. The non-transitory computer-readable storage medium of claim 15, wherein the sub-band comprises a plurality of time slots, and wherein the plurality of time slots is allocated at least one type of transmission.

17. The non-transitory computer-readable storage medium of claim 15, wherein the guest operator is not a boundary guest operator of the telecommunications network.

18. The non-transitory computer-readable storage medium of claim 15, further comprising:
dividing the frequency band into a plurality of sub-bands comprising the sub-band;
assigning, to each sub-band of the plurality of sub-bands, a respective guest operator of a plurality of guest operator of the telecommunications network; and
allocating, for each sub-band assigned to the respective guest operator, at least one type of transmission to a plurality of time slots of the sub-band.

19. The non-transitory computer-readable storage medium of claim 15, wherein a second downlink to uplink ratio associated with a second guest operator assigned to a second sub-band of the frequency band is static.

20. The non-transitory computer-readable storage medium of claim 19, wherein the second guest operator is a boundary guest operator of the telecommunications network.
